(19) United States
(12) Patent Application Publication
(10) Pub. No.: US 2026/0208085 A1
(43) Pub. Date: Jul. 23, 2026

(54) Graphene Functionalized HEPA Filter

(71) Applicant: University of Connecticut, Farmington, CT (US)

(72) Inventors: Douglas H. Adamson, Mansfield, CT (US); Robert Williams, Coventry, CT (US)

(73) Assignee: University of Connecticut, Farmington, CT (US)

(21) Appl. No.: 19/569,000

(22) Filed: Mar. 17, 2026

Related U.S. Application Data
(60) Provisional application No. 63/722,911, filed on Nov. 20, 2024.

(51) Int. Cl. B01D 46/00; B01D 39/20; B01D 46/10

(52) U.S. Cl. CPC B01D 46/0032; B01D 39/2017; B01D 46/10; B01D 2239/0208; B01D 2239/0435; B01D 2239/0492

(57) ABSTRACT

Filtration media and methods for providing filtration are provided, including High Efficiency Particulate Air (HEPA) filtration media and HEPA filtration. The filtration media include glass fibers and a graphene coating on the glass fibers. The graphene-coated glass fibers form/define a conductive coating. The graphene-coated glass fibers maintain the particulate filtration functionality of a HEPA filter while adding an electrostatic filtration capability.

### 1. CROSS REFERENCE TO RELATED APPLICATION

The present application claims priority benefit to a US provisional patent application entitled “Graphene Functionalized HEPA Filter” which was filed on Mar. 17, 2025, and assigned Ser. No. 63/772,911. The entire content of the foregoing U.S. provisional patent application is incorporated herein by reference.

### BACKGROUND OF THE INVENTION

### 2. Field of the Invention

The invention disclosed herein relates to high efficiency particulate air (HEPA) filters, and in particular to media for HEPA filters.

### 2. Description of the Related Art

There are currently two main methods of air filtration, namely, electrostatic precipitation and HEPA filtration. Electrostatic precipitation uses an ionizer to induce a charge in air-borne particles, which are then attracted to charged plates in the filter downstream. HEPA filtration removes particles by streaming air through a mat composed of micron thin glass fibers. Here, the particles are filtered out due to the intrinsically small size of the pores in the glass fiber mat.

Generally, a HEPA air purifying device is an advanced filtration system designed to remove airborne particles, including dust, pollen, pet dander, mold spores, and microscopic pathogens, from indoor air. It operates by drawing air through a dense HEPA filter, which consists of tightly woven fibers capable of trapping at least 99.97% of particles as small as 0.3 microns. Many HEPA air purifiers also incorporate additional filtration stages, such as pre-filters to capture larger debris, activated carbon filters to neutralize odors and volatile organic compounds (VOCs), and ultraviolet (UV) or ionization technologies to enhance sterilization. These devices are commonly used in homes, offices, hospitals, laboratories, and industrial settings to improve air quality, reduce allergens, and minimize airborne contaminants. Equipped with variable fan speeds, smart sensors, and air quality indicators, modern HEPA air purifiers automatically adjust their filtration performance based on real-time environmental conditions. Their quiet operation and energy-efficient design make them suitable for continuous use in occupied spaces. By effectively capturing airborne pollutants, HEPA air purifiers contribute to healthier indoor environments, particularly for individuals with respiratory conditions, allergies, or sensitivities to air pollution.

HEPA filters are typically glass or other fiber-based filters which prevent particles from passing through sensitive areas through mechanical filtration. There also exist ionization filters, which work by charging particulate matter and using electrostatic interactions to remove and filter out particulate matter (electrostatic precipitation).

High-efficiency particulate air (HEPA) filters remove airborne particles through mechanical filtration. These filters meet specific efficiency standards, capturing at least 99.97% of particles with a diameter of 0.3 microns. HEPA filters are widely used in medical facilities, cleanrooms, industrial settings, and residential applications to improve air quality by removing dust, pollen, mold spores, bacteria, and airborne contaminants. The filtration process relies on a combination of diffusion, interception, and impaction to trap particles within the filter media.

The filter media serves as the primary component that determines filtration performance. Traditional HEPA filter media consist of randomly arranged fibers, typically composed of fiberglass or synthetic materials. The fiber diameter, packing density, and thickness of the media influence airflow resistance and filtration efficiency. Although conventional HEPA media provide high particle capture efficiency, the associated pressure drop restricts airflow, increasing energy consumption in ventilation systems. As industries demand improved air filtration with lower operational costs, advancements in filter media composition and structure have become necessary.

Improvement of HEPA filter media focuses on reducing airflow resistance while maintaining or enhancing filtration efficiency. Nanofiber-based media, electrostatically charged fibers, and hybrid materials with composite structures offer potential solutions. These innovations aim to increase particle capture efficiency at lower pressure drops, enabling reduced energy consumption and extended filter lifespan. Additionally, enhanced media designs improve resistance to clogging and enable better performance in high-humidity or chemically reactive environments. Addressing these challenges ensures that HEPA filters continue to meet evolving air quality and energy efficiency requirements.

Thus, what are needed are methods and apparatus to improve HEPA filter media.

### SUMMARY

Filtration media and methods for providing filtration are provided, including High Efficiency Particulate Air (HEPA) filtration media and HEPA filtration. The filtration media include glass fibers and a graphene coating on the glass fibers. The graphene-coated glass fibers form/define a conductive coating. The graphene-coated glass fibers maintain the particulate filtration functionality of a HEPA filter while adding an electrostatic filtration capability.

In an embodiment, a filtration media includes (i) a plurality of glass fibers, and (ii) a graphene coating on the plurality of glass fibers. The graphene-coated glass fibers may define a filter mat.

The graphene may be pristine graphene. The graphene may be coated onto the glass fibers by way of a solvent interfacial trapping method.

The filtration media may function as a HEPA filtration media. The graphene coating of the filtration media may be effective to support electrostatic precipitation in response to charge application. The graphene-coated glass fibers may support electrostatic precipitation and HEPA filtration.

In an embodiment, a HEPA filter is provided that includes a HEPA filtration media, wherein the HEPA filtration media includes (i) a plurality of glass fibers, and (ii) a graphene coating on the plurality of glass fibers.

The graphene-coated glass fibers of the HEPA filtration media may define a filter mat. The graphene may be pristine graphene. The graphene may be coated onto the glass fibers by way of a solvent interfacial trapping method.

The HEPA filtration media functions as a HEPA filtration media within a HEPA filtration system. The graphene coating of the HEPA filter may be effective to support electrostatic precipitation in response to charge application. The graphene-coated glass fibers of the HEPA filter support electrostatic precipitation and HEPA filtration.

In an embodiment, a system is provided for filtering particles from air that includes: a filtration media that includes (i) a plurality of glass fibers, and (ii) a graphene coating on the plurality of glass fibers; and filtering particles from air using the filtration media. The system may further include charge application to the filtration media which may cause electrostatic precipitation of particles.

The system may be effective to effectuate HEPA filtration. The system may be effective for the filtering of particles from air by electrostatic precipitation and HEPA filtration.

The system may be effective for filtering of particles from air in any one of the following applications: an air purifier, a vacuum cleaner, an HVAC system filters, a medical-grade HEPA filter, an industrial HEPA filtration system, a cleanroom filtration system, a HEPA-equipped fume hood, a biosafety cabinet, an aerospace filtration system, a transportation filtration system, a nuclear filtration system, and a hazardous material filtration system.

Additional features, functions and benefits of the disclosed invention will be apparent from the description which follows, particularly when read in conjunction with the accompanying figures.

### BRIEF DESCRIPTION OF THE DRAWINGS

The features and advantages of the invention are apparent from the following description taken in conjunction with the accompanying drawings in which:

FIGS. 1A-1C are schematic diagrams depicting aspects of a coating process;

FIGS. 2A-2C are photographic images of progression of a graphene coating process for different graphite levels;

FIGS. 3A-3C are a series of micrographs of a graphene-coated glass fiber;

FIG. 4 is a plot of filtering efficiency versus time; and

FIG. 5 is a schematic diagram of a HEPA filtration system.

### DETAILED DESCRIPTION OF THE INVENTION

Disclosed herein are filtration media and methods for providing filtration, including High Efficiency Particulate Air (HEPA) filtration media and HEPA filtration. In an embodiment, methods for producing HEPA media are provided that entail, inter alia, coating glass fibers with graphene. That is, graphene may be used to coat glass fibers that are then used as a High Efficiency Particulate Air (HEPA) filter media. The graphene-coated glass fibers form/define a conductive coating. The graphene-coated glass fibers maintain the particulate filtration functionality of a HEPA filter while adding an electrostatic filtration capability.

In an embodiment, an iterative step is introduced to the manufacturing process wherein the glass fibers are coated with graphene. This allows a charge to be passed through the filter/filter media, whereby the graphene-coated glass fibers exhibit properties similar to electrostatic precipitation while maintaining the properties of HEPA filtration.

In an embodiment, glass fibers may be coated with exfoliated graphene prior to the glass fibers being potted in a polymer rim, thereby creating an interconnected network of electrically conductive glass fibers.

Coating of glass fibers with exfoliated graphene has been demonstrated to create electrically conductive HEPA filters/filter media capable of removing particles by electrostatic precipitation while maintaining the intrinsic filtering properties of HEPA filtration. Advantageously, the addition of graphene to the surface of the glass fibers can additionally provide an antimicrobial effect.

To increase the filtering efficiency of HEPA filters/filter media that include graphene-coated glass fibers, the pore size of the randomly aligned fibers may be reduced, thereby creating an ultra-low particulate air (ULPA) filter. ULPA filters/filter media generally exhibit reduced particle penetration, generally require greater back pressure for filtration applications which translates to greater cost. However, ULPA filters/filter media produced with graphene-coated glass fibers according to the present disclosure increase the effective diameter of the fibers due to the imposed electric field from the charge. The decrease in effective pore size translates to greater filtering efficiency in ULPA implementations due to the filtering properties of electrostatic precipitation associated with the graphene coating, while allowing air to pass freely through the large pore filter, decreasing the energy needed to filter the air. The longevity of the filters are improved because the filter is able to self-sanitize.

Thus, filters/filter media according to the present disclosure combine the benefits of the two filter types - electrostatic precipitation and HEPA filtration—into one, based on graphene coating of the fibers. The addition of graphene to the surface of the glass fibers can have an antimicrobial effect, offering a potential value addition to the product.

In an embodiment, a graphene emulsion climbs the glass fibers, resulting in fibers coated with graphene. The solvent layers may be evaporated after initial treatment, forming a robust fiber system/media that can be made into a HEPA filter. Once coated and assembled, the resultant graphene-coated fibers are conductive and can have current run through them (kilo to mega Ohm sheet resistances may be achieved). Generally, the fibers retain their geometric ability to act as a HEPA filtration medium and deliver increased filtering efficiency when current is supplied, through the added effect of electrostatic precipitation.

In an embodiment, the glass fibers may define an average fiber diameter in a range of about 0.1 microns to about 20 microns. In further embodiments, the average fiber diameter may be in a range of about 0.2 microns to about 10 microns, about 0.3 microns to about 5 microns, or about 0.5 microns to about 3 microns. The glass fibers may further define an average fiber length in a range of about 50 microns to about 50 millimeters. In further embodiments, the average fiber length may be in a range of about 0.1 millimeters to about 25 millimeters, about 0.5 millimeters to about 10 millimeters, or about 1 millimeter to about 6 millimeters. The present disclosure is not limited to a monodisperse fiber population, and multimodal fiber size distributions may be used.

In an embodiment, the filtration media may include a blend of glass fibers having different diameters and/or different lengths. A first population of finer glass fibers may provide increased particle interception and diffusion capture. A second population of coarser glass fibers may provide structural support, reduced flow resistance, and improved maintenance of pore pathways through the filter mat. The ratio between the first population and the second population may be selected to balance filtration efficiency, pressure drop, mechanical strength, and conductivity after graphene coating. Thus, the filtration media may include uniform fibers, bimodal fibers, or multimodal fibers.

In an embodiment, the graphene-coated glass fibers may be assembled into a mat having a thickness in a range of about 0.1 millimeters to about 50 millimeters. In further embodiments, the mat thickness may be in a range of about 0.2 millimeters to about 25 millimeters, about 0.5 millimeters to about 10 millimeters, or about 1 millimeter to about 5 millimeters. The filtration media may further define a basis weight in a range of about 5 grams per square meter to about 500 grams per square meter, and in some implementations in a range of about 20 grams per square meter to about 250 grams per square meter. The filtration media may define a porosity selected to maintain through-flow of air while also supporting mechanical capture of particles and electrically assisted capture of particles.

In an embodiment, the filtration media may be formed as a single-layer structure or as a multilayer structure. The multilayer structure may include two layers, three layers, four layers, five layers, or a greater number of layers. Each layer may include graphene-coated glass fibers, or one or more layers may include uncoated glass fibers, support scrims, spacer layers, protective facings, or combinations thereof. A first upstream layer may be configured for capture of larger particles and for protection of downstream layers. A second downstream layer may be configured for increased fine particle capture. In this manner, the filtration media may be tuned for service life, pressure drop, and filtration efficiency.

In an embodiment, the multilayer structure may define a gradient through the thickness of the filtration media. The gradient may be a gradient in fiber diameter, fiber packing density, pore size, graphene loading, electrical resistance, hydrophobicity, or combinations thereof. By way of example, an upstream layer may include coarser fibers and larger pores to reduce premature clogging, while a downstream layer may include finer fibers and smaller pores to capture smaller particles. By way of further example, graphene loading may increase through successive layers so that an electric field effect is stronger in downstream regions where smaller particles remain suspended in the air stream.

In an embodiment, the graphene coating may be continuous over substantial portions of individual fibers, discontinuous at spaced-apart regions along the fibers, or present as an interconnected network bridging adjacent fibers. The amount of graphene associated with the fibers may be selected to provide conductivity without materially occluding the pore network of the filter mat. Thus, the graphene may form conductive pathways across fiber-fiber contact points while preserving airflow through interstitial voids between the fibers. In some implementations, the graphene-coated glass fibers may define a sheet resistance, bulk resistance, or resistance per unit area selected to permit charge application across the filter media during operation.

In an embodiment, adjacent layers of the filtration media may be compressed to different extents during assembly. A first layer may be lightly compressed to preserve larger flow channels. A second layer may be more densely compacted to increase residence time of particles in the vicinity of conductive fibers. The degree of compression, calendering, or densification may therefore be selected as a design variable that affects permeability, particle capture, mechanical stiffness, and electrical continuity through the media.

In an embodiment, fabrication of the filter media introduces an iterative step in the manufacturing process after the glass fibers are formed that then coats the glass fibers with graphene. This allows a charge to be passed through the filter/filter media which introduce the properties similar to electrostatic precipitation while maintaining the properties of HEPA filtration.

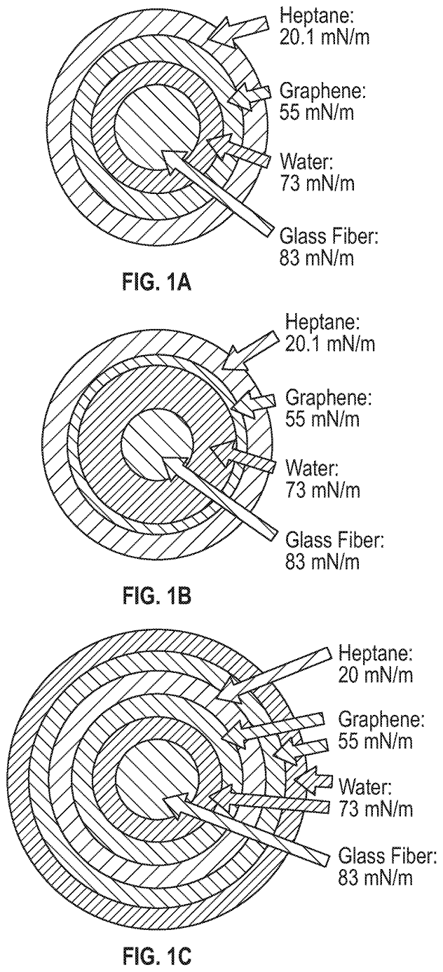

With reference to FIGS. 1A-1C , a progression of a coating process is schematically depicted, showing the glass fiber in the middle with water, graphene and heptane layers concentrically coating the fiber. The numbers are the surface tensions of each component.

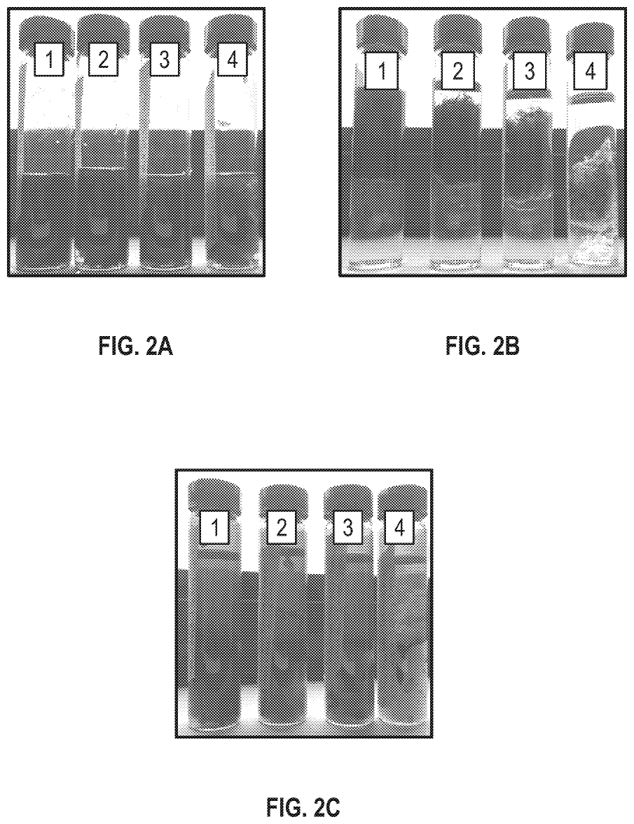

With reference to FIGS. 2A-2C , each of the noted figures includes photographs of four (4) vials at various stages of the coating process. The vials are designated as vial “1”, vial “2”, vial “3” and vial “4”. The difference between the systems shown in the four (4) vials is the amount of graphite added to each system. Vial 1 contains 30 mg of graphite, vial 2 contains 10 mg of graphite, vial 3 contains 5 mg of graphite and vial 4 contains 2.5 mg of graphite.

FIG. 2A shows the condition of a graphene coating process, where each vial contains heptane, glass fibers (trace amounts of water bound to fibers), and the above-stated amount of graphite after a thirty (30) second manual shake. FIG. 2B shows the subsequent condition of a graphene coating process for vials 1-4 after the addition of additional of water. FIG. 2C shows the subsequent condition of a graphene coating process relative to FIG. 2B for vials 1-4 after a thirty (30) second manual shake with coated fibers migrating to the water phase.

An example of a procedure for producing graphene-coated glass fibers for use in a HEPA filter media/filter is provided. In the example procedure: 1.97 g of glass fibers (0.23 wt %), are placed on a watch glass, and heated at 150° F. in an oven for ten (10) minutes. The warm glass fibers are added to a Waring commercial blender with 500 mL of heptane. The heptane and glass fibers are blended in the Waring blender for four (4) minutes. The resultant slurry is generally homogenous without noticeable clumps. The slurry is poured into a 500 mL beaker, and then transferred into a 1000 mL Erlenmeyer flask. 980 mg of N24 graphite (0.12 wt %) is added to the Erlenmeyer flask, the flask is capped and shaken manually for 30 seconds. All of the fibers generally “turn black” and the graphite is completely dispersed. Add 500 mL of 0.1M NaCl to the Erlenmeyer flask. The water phase moves to the bottom of the Erlenmeyer flask while graphene composite coated fibers (GCGF) in the heptane phase remains in the upper region.

The Erlenmeyer flask is re-capped and shaken manually for 30 seconds. The glass fibers remain coated and drop to the water phase. The heptane phase should have no residual fibers yet a thin layer of graphene coats the sides of the Erlenmeyer flask. The contents of the Erlenmeyer flask are poured into 1000 mL beaker which is covered with watch glass and microwaved (30Power, 150 sec). The slurry is poured back into the 1000 mL Erlenmeyer flask and re-capped. The Erlenmeyer flask is shaken manually for 30 seconds. The slurry is then sonicated for 180 seconds.

The heptane emulsions may break, resulting in heptane traveling to the top layer. The free heptane is manually decanted (and the decanted/residual heptane may be re-used in future operations). 500 mL of 0.1M NaCl is added to the Erlenmeyer flask (to increase the overall volume and increase fiber dispersity).

A 140 mm diameter Buchner funnel is attached to 4 L suction flask and level is ensured. 125 mm diameter Whatman paper is added and wetted prior to pouring solution. The solution is poured and filtered via aspirator. If all of the slurry does not fit, the remainder is added in a circular pattern when there is space to do so.

Once liquid has drained and filter is semi-damp, remove suction flask from the aspirator and connect to a membrane pump and pull suction. After no additional liquid can be removed, remove from suction and scrape sides of the Buchner funnel. Using a long flexible spatula, remove the newly created filter mat (GCGF HEPA filter media). Via tweezers, remove the Whatman paper from the filter media and let sample dry overnight on a paper towel.

With reference to the above-described procedure for producing graphene-coated glass fibers for use in a HEPA filter media/filter, the coating mechanism takes advantage of a solvent interfacial trapping method (SITM), a scalable technique that produces high-quality, pristine graphene by exfoliating graphite at liquid-liquid interfaces without chemical modification or degradation. SITM uses graphene as a 2D surfactant to create conductive, high-strength composites. Thus, upon shaking the contents within the vial as described above (0.075 g of glass fibers (0.55wt %), 20mL of heptane, and “x” amount of graphite), the fibers become black due to graphene/graphite coating. The amount of graphite may vary (as conveyed by the “x” amount referenced above). For example, as described with reference to FIGS. 2A-2C (described in greater detail below), the graphite may be added in amounts of 30 mg, 10 mg, 5 mg, and 2.5 mg. In an embodiment, the graphite may be added to the above-described system at a level of 980 mg. The present disclosure is not limited by or to such graphite amounts/ratios, but may be included in the graphene coating process at any desired level provided effective coating may be achieved.

The graphite serves as a surfactant between the water-oil interface (the water is wetting the surface of the glass), resulting in exfoliation of graphene which coat the fibers to minimize surface area between the oil and water. The use of an oven to initially treat the glass fiber standardizes the amount of water on the glass fibers, but does not remove it completely. As a result, adding heptane and graphite to the vials (as shown in FIG. 2B) allows a water-heptane phase to develop, forming a heptane-graphene-water-glass fiber interface. At this point, exfoliation is driven by thermodynamics with manual shaking speeding up the exfoliation.

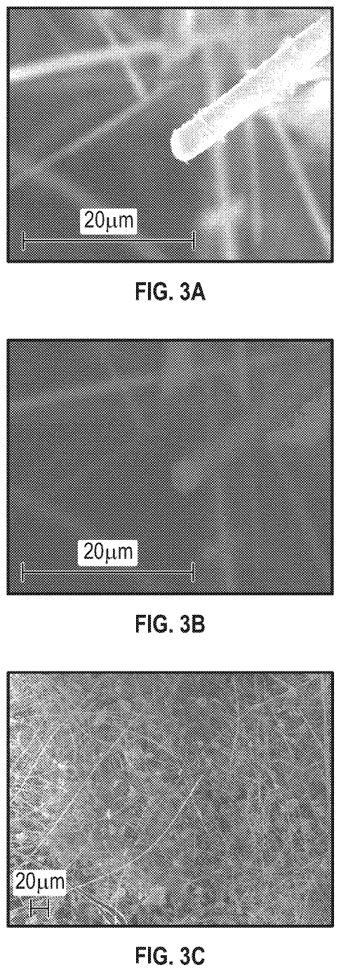

FIGS. 3A-3C provide a series of SEM images of glass fibers coated with graphene for use in or as a HEPA filter/filter media.

In an embodiment, graphene coating of glass fibers as described herein provides a conductive pathway without significantly increasing the diameter of the glass fibers. Using a TSI-8130A filter tester, it was demonstrated that the application of an electric potential directly affected the number of particles passing through the filter.

In an embodiment, electrical coupling to the filtration media may be provided at one edge, at opposite edges, at opposed faces, through a conductive frame, through embedded conductors, through conductive adhesive, through mechanical clamps, or through other electrical contacts placed in communication with the graphene-coated glass fibers. The electrical contacts may be positioned so that charge is distributed across a selected area of the media rather than concentrated at a single point. In some implementations, the filter media may be segmented into independently addressable conductive regions to permit zone-based energization.

In an embodiment, the filtration media may be operated under a direct current bias, a pulsed bias, or an alternating bias. The applied potential may be selected in relation to filter thickness, graphene loading, humidity, air velocity, and desired particle capture behavior. The electrical operating condition may be chosen to increase capture of fine particles while limiting arcing, dielectric breakdown, ozone generation, or excessive power consumption. Thus, the media may operate as a mechanically filtering structure that also provides electrically assisted particle attraction.

In an embodiment, the filtration media may define a pressure drop at a selected face velocity that is lower than a pressure drop of a comparator media having an equivalent particle removal target but lacking electrical assistance. In another embodiment, the filtration media may define a particle capture efficiency at a selected pressure drop that is greater than a particle capture efficiency of a comparator media lacking the graphene coating and charge application. Accordingly, the media may be configured around a target balance between efficiency, pressure drop, energy consumption, and service life rather than around any single variable in isolation.

In an embodiment, the filtration media may include an upstream sacrificial layer, a replaceable prefilter layer, or a washable coarse layer positioned ahead of one or more graphene-coated glass fiber layers. Such arrangements may extend service life by reducing loading of the conductive layer with larger debris. In another embodiment, a downstream support layer may stabilize the graphene-coated layer during pleating, potting, frame installation, or cyclic fan operation. The disclosed media may therefore be implemented in flat-sheet, pleated, cylindrical, panel, cartridge, and cassette formats.

In an embodiment, the graphene-coated glass fibers may be incorporated into a pleated filter pack. Pleat depth, pleat pitch, and pleat count may be selected in conjunction with media stiffness and conductivity to provide a desired effective surface area. A pleated configuration may increase available filtration area per unit housing volume while also permitting electrical connection to multiple pleat regions through conductive end structures or conductive separators. The filtration media may therefore be used in retrofit filters as well as in purpose-built energized filtration modules.

In an embodiment, the filtration media may be used in environments having elevated humidity, biologic loading, chemical vapors, smoke, metal particulates, combustion aerosols, radioactive particles, or combinations thereof. The graphene coating may improve charge distribution and may also provide a surface condition that differs from untreated glass fibers with respect to particle adhesion, microbial interaction, or resistance to fouling. Accordingly, the filtration media may be tailored for healthcare, laboratory, industrial, transportation, and controlled-environment applications.

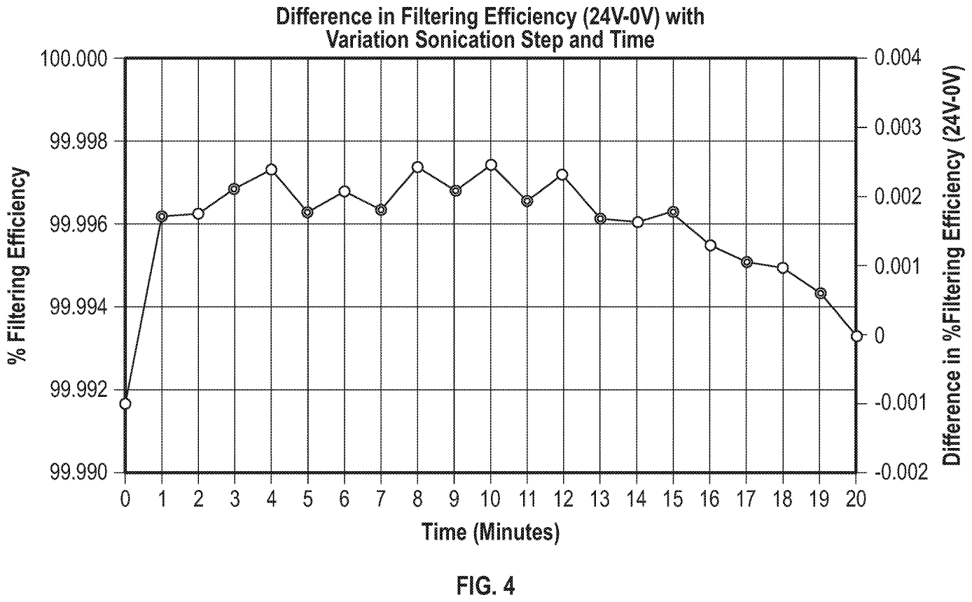

FIG. 4 shows the effect of applying a potential to and removing a potential from a filter/filter media over time. The % filtering efficiency goes up when the potential is applied and goes down when the potential is removed. The initial jump in efficiency is well known for HEPA filters as the large pores are quickly filled. This is followed by the filtration region and the region where the efficiency declines as the filter is saturated. The critical part is the middle region, where the efficiency of the filter increases while there is a potential and decreases when the potential is turned off, a beneficial result achieved by reason of the graphene-coating described herein. The graphene coating thus offers a beneficial approach in, for example, removing small particles from air.

FIG. 4 provides a plot of filtering efficiency versus time as a 24V potential is applied at the “double circle” points and turned off at the “hollow circle” points. The trajectory of increased efficiency for an electrified filter is demonstrated by the results shown in FIG. 4.

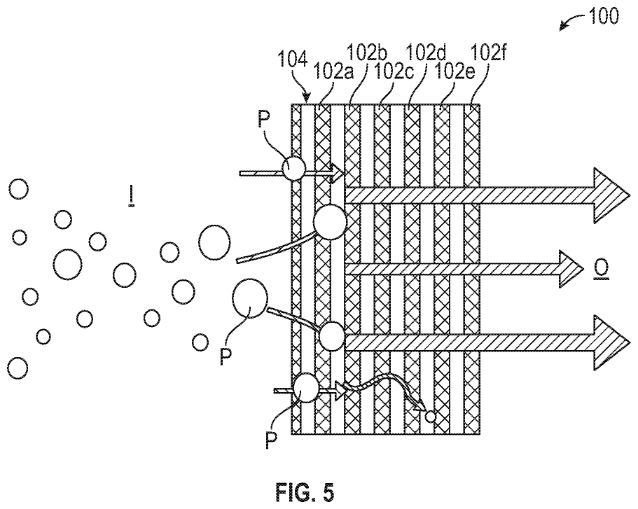

The filtration media that include graphene-coated glass fibers have many applications, including HEPA devices. An example of a HEPA system is shown in FIG. 5, wherein a HEPA system 100 includes series of HEPA filtration media 102a, 102b, 102c, 102d, 102e, 102f. The HEPA filtration media 102a-102f are positioned within a HEPA filtration apparatus 104. Air is introduced to one side of the HEPA filtration apparatus 100 (intake “I”) and exits through an opposite side of the HEPA filtration apparatus 100 (Outflow “O”). Particles “P” are filtered from the air as it passes through the HEPA filtration apparatus 100.

HEPA devices are used in various industries and applications to filter airborne particles, providing cleaner air in environments where air quality is crucial, and filter media that include the disclosed graphene-coated glass fibers have applicability in any/all such applications. Common HEPA devices include air purifiers, vacuum cleaners, and HVAC system filters, which are used in homes, offices, and healthcare facilities to remove allergens, dust, and microorganisms from the air. Medical-grade HEPA filters are integral to hospital environments, particularly in operating rooms and isolation wards, to prevent the spread of airborne infections. Industrial HEPA filtration systems are widely employed in cleanrooms for semiconductor manufacturing, pharmaceuticals, and biotechnology to maintain sterile conditions by trapping airborne contaminants. Laboratories and research facilities also rely on HEPA-equipped fume hoods and biosafety cabinets to protect personnel from hazardous particles and pathogens. Additionally, HEPA filtration is essential in aerospace and transportation, including aircraft cabins and automotive air systems, to ensure passengers breathe purified air. In nuclear and hazardous material handling, HEPA filters are critical for containing radioactive or toxic particulates. Furthermore, vacuum systems in asbestos removal projects utilize HEPA filtration to prevent the spread of dangerous fibers. The broad range of HEPA applications highlights the many applications of the disclosed filtration media that include graphene-coated glass fibers for maintaining air purity across various sectors.

Numerous manufacturers produce HEPA filtration equipment to meet these diverse applications. Companies such as Honeywell, 3M, and IQAir specialize in residential and commercial air purifiers, offering advanced filtration solutions for allergy and asthma sufferers. Dyson, Shark, and Miele incorporate HEPA filters into their vacuum cleaners, ensuring efficient removal of dust and allergens from indoor spaces. In the medical and laboratory sectors, Camfil, AAF Flanders, and Filtration Group provide high-efficiency filters for hospitals, pharmaceutical manufacturing, and cleanrooms, ensuring sterility and contamination control. Aerospace and transportation industries benefit from HEPA filtration systems developed by companies like Pall Corporation, Donaldson Company, and Parker Hannifin, which manufacture air filtration components for aircraft cabins and automotive ventilation systems. In industrial and hazardous material applications, Nilfisk, Abatement Technologies, and Air Scrubbers, Inc. produce HEPA-equipped vacuum systems and containment units for asbestos abatement, nuclear facilities, and biohazard control. With a broad range of manufacturers catering to specific needs, the disclosed filtration media that include graphene-coated glass fibers may be used for air purification and environmental safety across multiple industries.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Various other components may be included and called upon for providing for aspects of the teachings herein. For example, additional materials, combinations of materials and/or omission of materials may be used to provide for added embodiments that are within the scope of the teachings herein. Adequacy of any particular element for practice of the teachings herein is to be judged from the perspective of a designer, manufacturer, seller, user, system operator or other similarly interested party, and such limitations are to be perceived according to the standards of the interested party.

In the disclosure hereof any element expressed as a means for performing a specified function is intended to encompass any way of performing that function including, for example, a) a combination of circuit elements and associated hardware which perform that function or b) software in any form, including, therefore, firmware, microcode or the like as set forth herein, combined with appropriate circuitry for executing that software to perform the function. Applicants thus regard any means which can provide those functionalities as equivalent to those shown herein. No functional language used in claims appended herein is to be construed as invoking 35 U.S.C. § 112(f) interpretations as “means-plus-function” language unless specifically expressed as such by use of the words “means for” or “steps for” within the respective claim.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements. The term “exemplary” is not intended to be construed as a superlative example but merely one of many possible examples.

What is claimed is:

1. A filtration media, comprising:
a. a plurality of glass fibers;
b. a graphene coating on the plurality of glass fibers.

2. The filtration media according to claim 1, wherein the graphene-coated glass fibers define a filter mat.

3. The filtration media according to claim 1, wherein the graphene is pristine graphene.

4. The filtration media according to claim 1, wherein the graphene is coated onto the glass fibers by way of a solvent interfacial trapping method.

5. The filtration media according to claim 1, wherein the filtration media functions as a HEPA filtration media.

6. The filtration media according to claim 1, wherein the graphene coating is effective to support electrostatic precipitation in response to charge application.

7. The filtration media according to claim 6, wherein the graphene-coated glass fibers support electrostatic precipitation and HEPA filtration.

8. A HEPA filter comprising a HEPA filtration media, wherein the HEPA filtration media comprises (i) a plurality of glass fibers, and (ii) a graphene coating on the plurality of glass fibers.

9. The HEPA filter according to claim 8, wherein the graphene-coated glass fibers define a filter mat.

10. The HEPA filter according to claim 8, wherein the graphene is pristine graphene.

11. The HEPA filter according to claim 8, wherein the graphene is coated onto the glass fibers by way of a solvent interfacial trapping method.

12. The HEPA filter according to claim 8, wherein the filtration media functions as a HEPA filtration media within a HEPA filtration system.

13. The HEPA filter according to claim 8, wherein the graphene coating is effective to support electrostatic precipitation in response to charge application.

14. The HEPA filter according to claim 13, wherein the graphene-coated glass fibers support electrostatic precipitation and HEPA filtration.

15. A system for filtering particles from air, comprising a filtration media that includes (i) a plurality of glass fibers, and (ii) a graphene coating on the plurality of glass fibers;
wherein the filtration media is configured to filter particles from air.

16. The system of claim 15, wherein the filtration media includes an applied charge.

17. The system of claim 16, wherein the applied charge of the filtration media is effective to cause electrostatic precipitation of particles.

18. The system of claim 16, wherein the charged filtration media is effective to filter particles from air by electrostatic precipitation and HEPA filtration.

19. The system of claim 15, wherein the filtration media is a HEPA filtration media.

20. The system of claim 15, wherein the filtration media is incorporated into an apparatus selected from the group consisting of an air purifier, a vacuum cleaner, an HVAC system filter, a medical-grade HEPA filter, an industrial HEPA filtration system, a cleanroom filtration system, a HEPA-equipped fume hood, a biosafety cabinet, an aerospace filtration system, a transportation filtration system, a nuclear filtration system, and a hazardous material filtration system.
